(19) United States
(12) Patent Application Publication
(10) Pub. No.: US 2004/0019899 A1
(43) Pub. Date: Jan. 29, 2004

(54) Method of and system for signal detection

(75) Inventor: Daniel Pelletier, Lake Peekskill, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V

(21) Appl. No.: 10/205,560

(22) Filed: Jul. 25, 2002

(51) Int. Cl. H04N 7/16

(52) U.S. Cl. 725/10

(57) ABSTRACT

The present invention provides a method of and system for controlling operation of a video system including a video source and a control device. The method comprises the steps of monitoring a screen area of the video source; determining whether the video source is on; detecting control signal from control device representative of a control function; performing control function in accordance with control signal if the video source is determined not to be on; and querying a user if the control function is to be performed if the video source is determined to be on. The invention further includes a system for controlling operation of a video source. The system comprises a video signal receiver for monitoring the video source and a processor for determining whether the video source is on, for detecting a control signal from a control device representative of a control function, for performing control function in accordance with control signal if the video source is determined not to be on, and for querying a user if the control function is to be performed if the video source is determined to be on.

### BACKGROUND

1. Field of the Invention

The present invention is directed to a method and system for detecting a television signal. In particular, the system and method of the invention improves the operability of television recording or recommending systems.

2. Description of the Related Art

As the number of channels available to television (TV) viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow for on-screen presentation of the available television programs.

While EPGs allow viewers to identify desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs or sports programming. Viewer preferences, therefore, can be applied to EPGs to obtain a set of recommended programs that may be of interest to a particular viewer.

EPGs can also be utilized by the recording television systems, to enable the user to schedule desired programs for recording.

Thus, a number of tools have been proposed for recording/recommending television programming systems also known as television program recorders/recommenders. The Tivo™ recorder/recommender system, for example, commercially available from Tivo, Inc., of Sunnyvale, Calif., allows viewers to rate shows using a “Thumbs Up and Thumbs Down” feature and thereby indicate programs that the viewer likes and dislikes, respectively. Thereafter, the Tivo™ receiver matches the recorded viewer preferences with received program data, such as an EPG, to make recommendations tailored to each viewer.

While such television recorder/recommender systems such as the Tivo™ system with all of its features, provide an enjoyable viewing experience for the viewer, they suffer from a number of limitations, which when overcome, further improve the operability of the systems. For example, current recorder/recommender systems don't know whether or not the user is currently watching a television show, because the system doesn't know if the television set is turned on.

When the recorder/recommender system has a show scheduled for automatic recording, the system needs to display a disruptive message on the screen to ask whether it is acceptable to change the channel on the tuner and switch to the recommended show, thus interrupting the user's viewing. The user at the time of the message display could be watching a program that has been previously recorded. Alternatively, the user could be watching a recording from a VCR, DVD or other video sources through the television set that has both, a tuner, which is usually tuned to channel 3-4, and an auxiliary input where the audio/video in/out cables are inserted. The current recorder/recommender systems don't know whether the television is being watched and whether the signal being watched is coming from the output of the recorder/recommender system, which would be affected by tuning of the receiver.

Therefore, if the program being watched would not be affected by tuning of the receiver, or if the user is not even watching television, there is no need to interrupt the viewing pleasure of the user by asking the user whether change of channel is acceptable.

One solution could allow the analysis to be done on the signal going into the audio/video in ports on the television, thus detecting the signal. However, the consumer would have to understand that if they switched from auxiliary to the television antenna, they would be getting a false read from the signal detector.

A need therefore exists for a method and a system for detecting a signal from any video source such as a television.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied and described, the invention includes a method of controlling operation of a video system including a video source and a control device. The method comprises the steps of monitoring a screen area of the video source; determining whether the video source is on; detecting control signal from control device representative of a control function; performing control function in accordance with control signal if the video source is determined not to be on; and querying a user if the control function is to be performed if the video source is determined to be on.

The invention further includes a system for controlling operation of a video source. The system comprises a video signal receiver for monitoring the video source and a processor for determining whether the video source is on, for detecting a control signal from a control device representative of a control function, for performing control function in accordance with control signal if the video source is determined not to be on, and for querying a user if the control function is to be performed if the video source is determined to be on.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a block diagram illustrating a system according to the preferred embodiment of the present invention;

FIG. 2 is a flow diagram illustrating an advantageous embodiment of a method of operation of the present invention; and

FIG. 3 is a flow diagram illustrating an advantageous embodiment of the method of operation in accordance with another embodiment of the present invention.

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

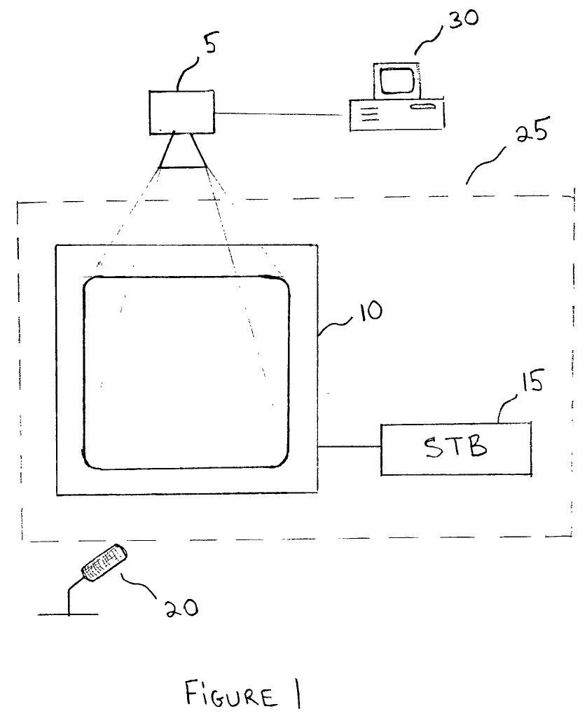

FIGS. 1, 2 and 3 discussed below, and the various embodiments herein to describe the principles of the system and method of the present invention, are by way of illustration only and should not be construed in any way to limit the scope of the invention. The system and method of the present invention will be described as a system for and a method of controlling operation of video system including a video source and a control device.

It is important to realize that the system and method of the present invention is not limited to television recording or recommending systems. Moreover, the invention is not limited to television signals. Those skilled in the art will readily understand that the principles of the present invention may also be successfully applied in any type of video system, including, without limitation, television receivers, set top boxes, storage devices, computer video display systems, and any type of electronic equipment that utilizes or processes video and audio signals. The term “television recording system” is used to refer to these and other similar types of equipment available now or in the future. In the descriptions that follow, a television recording/recommending system is employed as one representative illustration of a television system.

FIG. 1 is a block diagram illustrating a system according to the preferred embodiment of the present invention. The system for controlling operation of a video source comprises a television recording/recommending system 25, having a video signal receiver such as a video camera 5. According to another embodiment of the present invention, the system can comprise at least one microphone 20 for acquiring audio signals. The television recording/recommending system 25 typically includes a video source such as a television set 10 coupled to a control device such as a set-top-box 15 or equivalent hardware means capable of receiving and recording a television video/audio signal from a broadcasting station. The set-top-box 15 can also include recommending means for analyzing user's viewing preferences and recommending to the user future shows to be recorded. The set-top-box typically 15 comprises a processor and software means for processing a digital video/audio signal and outputting the signal to the television set 10 for display.

According to the preferred embodiment of the present invention, the system for detecting a television signal further comprises a video camera 5 pointed at the television set for recording an analog video signal displayed on the television set's screen. The camera 5 can be a digital video camera which automatically records the video signal in digital form. Preferably, the camera 5 is coupled to a computer 30. The computer 30 can be any type of a machine having processing means for processing the video/audio signal. The computer 30 can include an analog-to-digital converter for converting the received analog signal from the video camera 5 into a digital video/audio signal for further processing by the processing means. The computer 30 upon receiving the video/audio signal from the camera 5 preferably performs the video and audio signal analysis to determine whether the television set 10 is turned on and whether the television set is tuned to a known channel.

Alternatively, according to yet another embodiment of the present invention, the system illustrated in FIG. 1 can include an audio recording means, such as a microphone 20. The microphone 20 would record an audio signal played by the television set 10. This audio signal would be transmitted to the computer 30 for audio analysis to determine the location of the audio source, i.e. whether the sound is indeed coming from the television set, and hence determine whether the television set is on. The audio analysis would also determine whether the audio signal received is already known so as to avoid querying the user to change the channel. Multiple microphones can be utilized depending on the method of audio analysis implemented.

It should be understood that the particular configuration of the system as shown in FIG. 1 is by way of example only. In other embodiments of the invention, the video camera 5 and the microphone 20 can be placed in a variety of places as long as the video camera is capable of filming the screen area of the television set and the microphone is capable of receiving an audio signal coming from the television set 10. Alternatively, the configuration can be incorporated in the video source at the point where the signal enters the television set or monitor. For example, such point can be “video in” and “audio in” or “composite in.” Therefore, in the place of camera and microphone, the “line in” (composite or separate audio and video signals, or digital signals) could be monitored to determine what was being received by the television set. However, such alternative configuration would not be as accurate on television sets which are tuned to the antenna (typically channels 3 or 4) or to the AUX (or A/V) inputs as the preferred embodiment. Consequently, if the alternative embodiment were to be used, a warning can be added to let the user know that the system is less certain to determine what show is being watched and therefore can not detect if the television set is on or not.

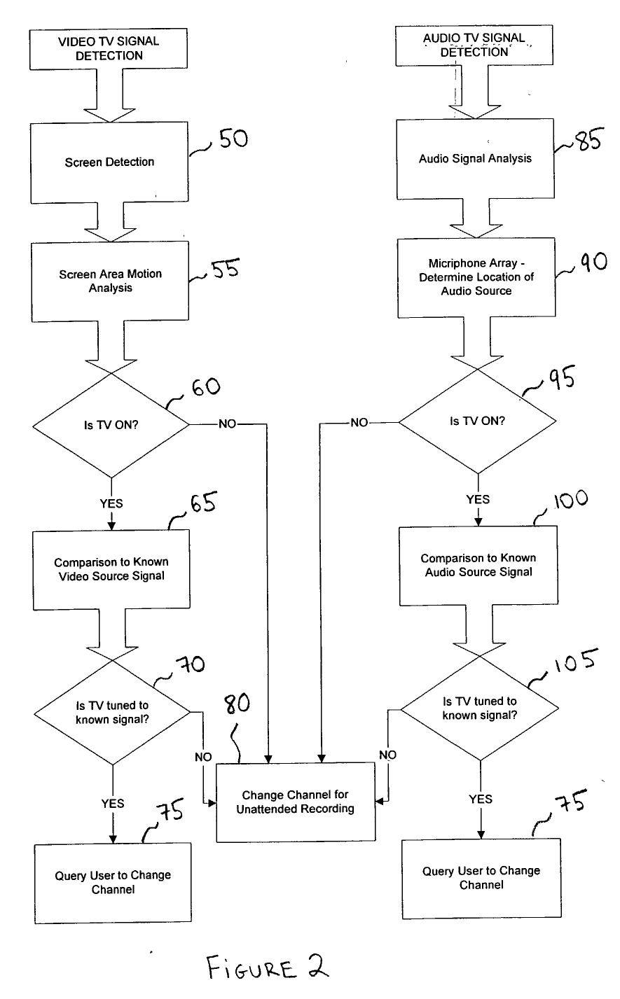

FIG. 2 is a flow diagram illustrating an advantageous embodiment of a method of operation of the present invention. In the video signal detection the first step is to detect the television set's screen (50). Means for detecting a recognizable shape such as a television set are well known in the art of computer vision. For example, video frames in the video signal are analyzed for edges that would define the exterior and interior shape of both standard and wide-screen television set aspect ratios. After the screen is detected the video camera can be pointed directly at the screen to record the analog video signal displayed by the television set 10. In step 55 screen area motion analysis is performed to determine whether the television set 10 is turned on. There are many well known methods in the art for analyzing motion in a video signal. For example, video signal typically consists of multiple image frames which are analyzed separately. Features such as color, shape, edge maps, cut rate, sampling rate and others are taken into consideration in the analysis process. Scales for equality between the signals are determined for each kind of analysis, leading to an overall comparison value. If the value is over a certain threshold, the images are considered to be the same.

If the television set is on (step 60) based on the screen area motion analysis 55, further processing of the video signal can be utilized to determine whether television is tuned to a known signal previously recorded by the set-top-box 15. For example, the video signal from the video camera 5 aimed at the television set 10 (signal “VSB”) can be compared to the video signal from a known source (signal “VSA”) such as the set-top-box 15, as compared to previously recorded material.

In step 5 two methods of video signal comparison can be implemented. Similar to step 55, signal VSA and VSB can be analyzed separately using well known in the art means of motion analysis, color analysis, etc. For example, the two video signals can be compared through visual appearance of frames. The visual similarity can be based on, e.g., color, shape, particular object similarity, or a conceptual type of object similarity, and may be, e.g., two-dimensional, 2.5-dimensional, i.e. computer vision, or three-dimensional.

The color similarity methods may implement, for example, distance between color histograms through the use of perceptually meaningful color spaces (HSV, RGB, . . . ). Typically, color similarity methods are relatively independent of illumination (color constancy). The use of texture comparison methods may involve texture feature extraction (statistical models). Texture qualitites such as directionality, roughness, granularity are typically taken into consideration.

Moreover, shape features such as circularity, eccentricity, principal axis orientation, etc. are utilized as well in the analysis of the video signals. Spatial characterisitcs where images are assumed to have been (automatically or manually) segmented into meaningful objects can be used and the spatial layout of the objects in the scene can be considered.

Generally, the above mentioned types of information associated with images or videos are used in the visual information retrieval systems, which are well known in the art. The types of information extracted generally include the following:

(1) Data not directly concerned with image/video content, but in some way related to it (and also referred to as content-independent metadata). Examples are: the format, the author's name, date, location, ownership, etc.

(2) Data which refer to the visual content of images, as mentioned above: low/intermediate-level features, such as color, texture, shape, spatial relationship, motion, and their combinations (also referred to as content-dependent metadata). These data typically regard perceptual facts.

(3) Content semantics, also referred to as content-descriptive metadata. These are data concerned with the relationships of image entities with real-world entities, or temporal events, emotions and meanings associated with visual signs and scenes.

Finally, the output profiles of the video signals can be compared and if the difference in profiles is within a predetermined threshold, the sources of video can be considered to be the same. Therefore, if the sources are the same, the television set is considered to be tuned to a known signal (step, 70). If the television set is tuned to a known signal, the television recording/recommending system 25 queries the user to change the channel (step 75). Conversely, if the television set 10 is tuned to an unknown video signal, the channel is changed for unattended recording because the tuner is free. The unknown video signal could be coming from an auxiliary input such as a DVD, VCR or other video devices.

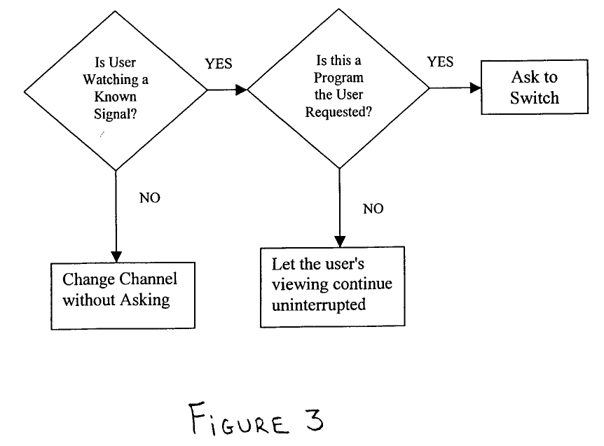

In accordance with one embodiment of the present invention, the intrusions on the user's viewing are reduced, i.e., the number of times the user is questioned is reduced. Therefore, if the user is not watching the current signal tuned in by the STB, the channel can be changed without asking the user's permission. However, if the user is watching the same (known) signal, the user is questioned. Alternatively, as illustrated in FIG. 3, a distinction can be made between shows the user has requested and the shows the system is recommending.

While the placement of the camera 5 should preferably be on top of the television set 10 so as to avoid blocking the video signal, various other places can be utilized as well. The video analysis according to the preferred embodiment of the present invention solves the problem of blocking. The analysis will determine if, in the larger percentage of the visible screen, the television set's output and the known video signal were compatible. A certain predetermined percentage of areas of the screen that were out of sync, e.g. 50%, would be acceptable as long as the other 50% was about 90% sure to be coming from the same signal. The certainty values can vary depending on the application.

In an alternative embodiment of the present invention, a different method of comparison of video signals can be implemented. Signals VSA and VSB can be compared to each other at a low level. For example, the optical flows of each signal can be compared. Optical flow, by definition, is the apparent motion of luminance patterns in the images (retinas). Under variably restrictive assumptions it can be assimilated to the motion of physical objects in the environment or to the self-movement of the cameras (eyes). In general, optical flow describes the relative motion of different parts of an image. Optical flow arises from the relative motion between the objects in the image and the viewer. Optical flow processing operates at the pixel level and can provide important information about the spatial arrangement of the objects being viewed and the rate of change of the space between objects. Discontinuities in the optical flow are used to segment images into regions that correspond to different objects. There are two general approaches for computing optical flow which are well known in the art: (1) gradient based methods based on spatio-temporal filtering using the optical flow constraints such as rigidity, smoothness and proximity; and (2) feature based methods (e.g., edges, corners). Any of the methods for computing the optical flow can be used in accordance with the present invention. Similarly to the first method of comparing the video signals, if the difference in optical flows is above a predetermined threshold, the video sources are considered to be the same.

Alternatively, according to another embodiment of the present invention, the method may include the step of detecting an audio signal in addition to the detection of the video signal. For example, the system can further comprise a microphone for receiving an analog audio signal coming from the television set. After receiving the analog audio signal, it may be converted into digital form for further analysis.

In a preferred embodiment, the audio analysis can include the means for determining the location of an audio source. FIG. 2 shows that at step 85 the audio signal received by the microphone 20 is first analyzed to determine the location of the audio source, i.e. whether the audio is coming from the television set 10.

Audio location detection methods are well known in the art. For example, a microphone array audio location algorithm can be used (step 90). Small microphone arrays typically consist of two to six microphones kept in close proximity. The source of sound is kept outside the array. The simplest array, the two-microphone array, provides the basis upon which the others are derived. Each microphone in an array has some time delay relationship with the other microphones in the array, dependent on the location of the sound source. Cross correlation performed on recorded sound data from the array returns the time delays of each pair of microphones in the array. From the observed time delays, the bearing of the sound source can be determined.

Cross correlation needs two sets of data in order to return a delay. Therefore, an array of at least two microphones is needed to gather any meaningful data. In a two-microphone array, one microphone is closer to the source than the other or they have no time delay and are equidistant from the source. The path difference varies from zero to a maximum. The maximum path difference for a two-microphone array is the distance between the two microphones, and it occurs when the source is collinear with the microphones. Zero path difference occurs when the source exists on the perpendicular bisector of the line segment between the two microphones. From the time delay, the path difference D is determined through the simple formula D=vt

where v is the speed of sound and t is the time delay.

Audio location algorithms determine the location of the source of an audio signal. If the source is the television set, the television set is assumed to be turned on (step 95). If the location of the audio source is something other than the television set, the television set is assumed to be off. However, in case the television set's volume is relatively low compared to other noises in the background, further analysis of the video signal can be performed. If the television set is determined to be off, the channel is changed automatically for unattended recording (step 80). If the television set on, further audio analysis can be done.

According to another embodiment of the present invention, the processing means acquire two audio signals—(1) ASA—Audio stream from a known source, such as a set-top-box, and (2) ASB—Audio stream from the camera aimed at the television set. The two audio signals can be analyzed separately using audio analysis techniques, which are well known in the art. For example, there are many features that can be used to characterize audio signals. Generally, the features can be classified into two categories: time-domain and frequency-domain. Features such as volume distribution, pitch contour, average energy, and frequency can be taken into consideration.

The volume distribution of an audio signal, for example, reveals the temporal variation of the signal's magnitude. To compute volume, an audio signal or clip can be divided into many overlapping frames and the root mean square (RMS) of the signal magnitude within each frame can be used to approximate the volume of that frame. The mean and standard deviation of the volume within a clip are used as descriptors of the volume distribution. In addition, to determine whether a frame is silent or not, the frame's volume can be compared to a threshold determined based on the volume distribution of the entire clip. From the result of silence detection, silence ratio, which is the ratio of the silence interval to the entire period, can be calculated. Typically this ratio varies significantly in different video sequences. In news reports, for example, there are regular pauses in the reporter's speech, while in advertisement programs there are always some background music which results in a low silence ratio. Moreover, pitch of an audio signal is the fundamental period of a human speech waveform, and is an important parameter in the analysis and synthesis of speech signals. In an audio signal, which generally consists of pure speech as well as many other sounds, the physical meaning of pitch is lost. However, the pitch can be used as a low-level feature to characterize changes in the periodicity of waveforms in different audio signals. There are many well known in the art pitch determination algorithms. Form example, an algorithm which uses the short time Average Magnitude Difference Function (AMDF) can be applied to determine the pitch of each frame. Some audio signals might not contain any speech. An alternative method can be used. For example, after computing the pitch of each frame, a pitch contour for the entire audio clip can be obtained. A median filter can then be applied to this contour to eliminate falsely detected pitches which often appear as spikes in the contour. The pitch level itself is typically influenced by the speaker (male or female) rather than the scene content. However, the pitch difference between adjacent frames appears to reveal scene content more. Therefore, the mean and standard deviation of the pitch difference can be used as two additional audio features. Based on the pitch estimation results, speech frames can be detected. Because a speech segment usually has a relatively constant pitch, only those frames which have smooth (compared to the previous frame) pitch periods are considered as speech frames. The speech ratio, which is defined as the ratio of the length of the speech frames to the entire audio clip, is used as another audio feature.

To obtain frequency features, the spectrogram of an audio signal can be calculated. The spectrogram is a 2D plot of the short-time Fourier transform (over each audio frame) along the time axis.

In general, various well known in the art audio feature extraction methods can be implemeted to analyze each audio signal and to compare them to each other (step 100). The output profiles of the audio signals, created by the above mentioned methods, can then be compared and if the difference in profiles is within a predetermined threshold, the sources of audio signals can be considered to be the same. If the sources are considered to be the same, the telvision set is tuned to an already known signal (step 105), in which case the user is prompted to change the channel (step 75). However, if the television set 10 is tuned to an unknown signal, the channel is changed for unattended recording.

Alternatively, according to yet another embodiment of the present invention, the two audio signals can be compared to each other at a low level.

The method and system of the present invention, as described above and shown in the drawings, provide for an improved functionality of a typical television recording/recommending system. In particular, the television systems will be able to detect a television signal and thus improve the automatic recording process.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. A method of controlling operation of video system including a video source and a control device, the method comprising the steps of:
monitoring a screen area of the video source;
determining whether the video source is on;
detecting control signal from control device representative of a control function;
performing control function in accordance with control signal if the video source is determined not to be on; and
querying a user if the control function is to be performed if the video source is determined to be on.

2. The method of claim 1, wherein the video source is a television set.

3. The method of claim 1, wherein the monitoring step includes detecting video signal from the video source.

4. The method of claim 3, wherein the step of determining whether the video source is on is performed using screen area motion analysis of the detected video signal.

5. The method of claim 1, further comprising the steps of:
comparing the detected video signal to a known video input signal if the video source is determined to be on to determine whether the video source is tuned to the known video input signal; and
further wherein the step of performing is performed if the detected video signal does not compare to the input signal, and the step of querying is performed if the detected video signal does compare to the known video input signal.

6. The method of claim 1, wherein the monitoring step includes detecting audio signal from the video source, wherein the video source is an audio source.

7. The method of claim 6, further including the step of determining a location of the audio source using a microphone array method.

8. The method of claim 6, further comprising the steps of comparing the detected audio signal to a known audio input signal if the audio source is determined to be on to determine whether the audio source is tuned to the known audio input signal; and
further wherein the step of performing is performed if the detected audio signal does not compare to the audio input signal, and the step of querying is performed if the detected audio signal does compare to the known audio input signal.

9. A system for controlling operation of a video source, the system comprising:
a video signal receiver for monitoring the video source;
a processor
for determining whether the video source is on,
for detecting a control signal from a control device representative of a control function,
for performing control function in accordance with control signal if the video source is determined not to be on, and
for querying a user if the control function is to be performed if the video source is determined to be on.

10. The system of claim 9, wherein the video source is a television set.

11. The system of claim 9, further comprising at least one microphone for monitoring an audio signal.

12. The system of claim 9, wherein the video signal receiver a video camera.
